(19) United States
(12) Patent Application Publication
(10) Pub. No.: US 2020/0338936 A1
(43) Pub. Date: Oct. 29, 2020

(54) UTILITY VEHICLE HAVING A CHASSIS ON WHICH A TIRE INFLATION SYSTEM CAN BE ARRANGED

(71) Applicant: SAF-HOLLAND GmbH, Bessenbach (DE)

(72) Inventor: Jochen Wenzel, Aschaffenburg (DE)

(21) Appl. No.: 16/612,640

(22) PCT Filed: May 16, 2018
(86) PCT No.: PCT/EP2018/062657

§ 371 Date: Nov. 26, 2019

(30) Foreign Application Priority Data
May 22, 2017 (DE) 10 2017 111 120.4

(51) Int. Cl. B60C 23/00; B60K 35/00; B60C 23/16

(52) U.S. Cl. CPC B60C 23/00336; B60K 35/00; B60K 2370/167; B60C 23/16; B60C 23/009

(57) ABSTRACT

A utility vehicle having a chassis on which a tire inflation system is configured to be arranged, wherein the chassis has at least one axle with a cavity which is embodied as a compressed-gas reservoir in which a gas at a specified gas pressure is stored for inflating a tire of the utility vehicle with the gas, wherein the compressed-gas reservoir has a wall with a compressive strength of at least 0.9 N/mm2, preferably at least 1.4 N/mm2.

### BACKGROUND OF THE INVENTION

The present invention relates to a utility vehicle having a chassis on which a tire inflation system can be or is arranged.

Known tire inflation systems obtain the required compressed gas for inflating or re-inflating a tire of a vehicle from a compressed-air tank of a trailer of the secondary consumers, such as for example of the lift axle or of the air suspension system etc. The maximum supply pressure at the junction with the trailer is by law at maximum 8.5 bar. In order to increase the pressure, in order, for example, to generate an air pressure of 9 bar in the trailer tires, it is therefore known to provide a booster pump before the gas is fed into the axle tubes of the chassis at the higher pressure level. As soon as a tire now loses gas pressure, the gas pressure is topped up in the corresponding tire until the preset tire gas pressure, in particular of at least 9 bar, is reached.

DE 10 2011 007 231 B4 is concerned with a wheel bearing arrangement which comprises a hollow body unit and a pressure space which extends along an axial direction, within the hollow body unit.

DE 10 2005 029 540 A1 is concerned with axle bodies which are embodied as compressed-air reservoirs.

DE 27 06 801 C2 discloses an axle structure for a vehicle, having a hollow axle body, at each of the two ends of which a running wheel is rotatably mounted, to which running wheel a brake which can be activated by means of a pressure medium, a control device and a reservoir space for the pressure medium are assigned, wherein the axle interior which is embodied as a reservoir space is provided with a plastic coating.

U.S. Pat. No. 6,398,236 B1 is concerned with axles which have a cavity, wherein the cavity functions as a compressed-air reservoir which is connected to a spring mechanism and/or a pneumatic lifting mechanism, in order to supply it with compressed air.

DE 10 2008 062 048 A1 relates to a tire pressure-regulating system for vehicles with pneumatic tires, which system has a pressure re-boosting pump as well as at least a tire pressure control valve.

DE 10 2008 062 071 A1 is concerned with a tire pressure-regulating system with a plurality of compressors.

DE 602 08 563 T2 discloses a monitoring system for a pressurized vessel.

It is currently known to use the axle tubes of the chassis as compressed-gas vessels, but the increase in the pressure level requires the necessary use of a booster pump in order to be able to supply the corresponding secondary consumer with gas pressure in an optimum way. In addition, there is a need for a connection to the gas pressure tank of the secondary consumers. The known tire inflation systems require a number of components which interact with one another and which each contribute to the susceptibility of the overall system to faults. In addition, the known tire inflation systems do not operate independently of the gas pressure circuit of the trailer, so that it is always necessary to ensure compatibility between a trailer or a utility vehicle and the corresponding tire inflation system.

In view of these problems in the prior art, the object of the present invention is to make available a utility vehicle with a chassis on which a tire inflation system can be or is arranged and which is less susceptible to faults and can be manufactured more cost-effectively, and operates independently of a compressed-gas circuit which is mounted on the vehicle.

### SUMMARY OF THE INVENTION

According to the invention, the utility vehicle, which is embodied in particular as a utility vehicle trailer, has a chassis on which a tire inflation system can be or is arranged, wherein the chassis has at least one axle with a cavity. In addition, the chassis is embodied as a compressed-gas reservoir in which a gas is stored at a specified gas pressure for inflating a tire of the utility vehicle with the gas. According to the proposal, the compressed-gas reservoir has a wall with a compressive strength of at least 0.9 N/mm2, preferably at least 1.4 N/mm2. The axles of the chassis are preferably formed from a material which has a higher compressive strength than a compressive stress which is applied to the axle by the specified tire gas pressure. It is conceivable to use a carbon fiber, in particular an anisotropic one, or a fiber-plastic composite (FPC) or a lightweight metal as a material for the axles of the chassis. For example, anisotropic carbon fibers have high strength and rigidity levels with at the same time low elongation at break in the axial direction. In addition it is conceivable to use a ceramic, in particular a high-performance ceramic, as a material for the axles of the chassis. In the case of the ceramic materials, it is not significant here which basic material, in particular boron nitride, silicon carbide or aluminum oxide forms the base body. Instead, the type and frequency of fault points, in particular pores, microfractures or very small quantities of extraneous substances influence the specific properties of the ceramics in the finished component. The application-related variation in the properties of ceramic materials therefore occurs to a much greater degree as a result of the configuration of the process steps, than is the case, for example, with metals. A wide variety of properties of the same mixture of substances can be obtained by means of different combustion methods and combustion atmospheres as well as by virtue of the particle size and combustion temperature. An example is reactive firing, with which silicon-enriched silicon carbide (SiC) is fabricated under protective gas from silicon powder and carbon powder. Without the otherwise customary shrinking during sintering, this permits complex, comparatively large, structures to be manufactured. SiSiC has, for example, a high degree of hardness, conductivity of heat, chemical stability and corrosion resistance of the silicon carbide, but the silicon embedded in the pores improves the oxidation resistance so that this ceramic is also suitable for use as a structural part in a chassis. The specified tire gas pressure is, for example, at least 9 bar, and the specified tire gas pressure preferably assumes a value between 12 to 14 bar. In order then to be able to inflate the tires of a vehicle with a tire gas pressure between 12 to 14 bar, it is necessary for the compressed-gas vessel to be designed for corresponding storage of a compressed gas. According to the proposal, the compressed-gas reservoir consequently has a wall with a compressive strength which is at least 0.9 N/mm2 and preferably at least 1.4 N/mm2. Overflowing of the gas out of the compressed-gas reservoir of the chassis into the tires of the utility vehicle can be implemented by increasing the gas pressure in the chassis to a significantly higher level. The described technical teaching can preferably be applied to utility vehicles. It is additionally conceivable to apply the technical teaching to passenger cars.

The utility vehicle is preferably constructed without a booster pump in the fluid system or line system or supply system which is provided for filling the compressed-gas reservoir. The use of a booster pump as well as a connection thereof to an external gas pressure reservoir of the secondary consumers can be dispensed with. The gas pressure is increased according to the proposal without using a booster pump which is arranged in the utility vehicle. In other words, the utility vehicle is embodied without a booster pump in the fluid system or line system or supply system which is provided for filling the compressed-gas reservoir. This has the advantage that the proposed system which comprises a chassis and a tire inflation system of a utility vehicle can be manufactured more cost-effectively and is less susceptible to faults, since the number of components which interact with one another is reduced.

The wall of the compressed-gas reservoir preferably has at least biaxial compressive strength, and preferably triaxial compressive strength. In the case of biaxial compressive strength, deformation is presented in one of two lateral or transversely extending directions, while in the case of triaxial compressive strength the deformation is prevented in both lateral or transversely extending directions. For example, the chassis or the axle could be formed from a fiber-plastic composite (FPC) or from a lightweight metal, such as for example aluminum, magnesium or titanium or the like, or a ceramic. It is also conceivable to manufacture the compressed-gas reservoir from any other material which has the desired compressive strength.

The compressed-gas reservoir can preferably be filled when necessary to a gas pressure which is higher than the specified tire gas pressure, in particular to at least 14 bar, by means of an external compressed-gas supply unit, wherein, in particular, the external compressed-gas supply unit comprises a compressor at a gas station or a workshop. Here, the term external compressed-gas supply unit is meant to refer to a compressed-gas supply unit which is positioned locally outside a utility vehicle or a trailer. This external compressed-gas supply unit is to be visited only when necessary, in particular only when the gas pressure in the compressed-gas vessel is lower than 9 bar, preferably lower than 14 bar, in order to refill the compressed gas in the compressed-gas vessel.

The gas pressure reservoir is also preferably fluidically connected to at least one axle stub via which the gas can be conducted into a tire, wherein the axle stub is preferably embodied at least partially as a gas reservoir. An axle stub between the chassis and a tire of the vehicle preferably serves as a mediator for the compressed gas, wherein the compressed gas is partially stored in the axle stub. For this purpose, the axle stub is embodied with a corresponding cavity or a gas line, which is preferably embodied as an internal wall of the axle stub. Air, carbon dioxide or an inert gas such as, for example, nitrogen, argon or a mixture of the specified gases, is preferably used as the compressed gas.

In addition, the at least one axle of the chassis preferably comprises an inflation unit, in particular a valve device, for inflation with the gas, in particular by means of the external compressed-gas supply unit. The inflation unit also preferably comprises a valve device which is preferably embodied, in particular, in a bidirectional fashion. As a result of the bidirectional embodiment of the valve device it is possible for gas to be conducted both into the gas pressure reservoir and out of it. A changed valve device preferably has a leakage protection. This can prevent gas from being able to escape into the surroundings via the valve device.

In addition, at least one sensor for, in particular continuously, acquiring a sensor signal, correlated with the specified gas pressure, is preferably arranged in the gas pressure reservoir, on the at least one axle. In the filled state of the gas pressure reservoir, the at least one axle of the chassis is under pressure, wherein when there is a possible rupture of an axle the compressed air can escape outward from the gas pressure reservoir. As a result of the escaping of the gas out of the gas pressure reservoir, the pressure in the gas pressure reservoir drops. Such a drop in pressure can be, for example, an indicator of a leak (fracture) in the chassis. In order to monitor the compressed-gas reservoir, a sensor, in particular a pressure sensor, for monitoring the gas pressure is mounted on the chassis.

In addition, the at least one sensor is preferably connected to a controller which is designed to receive and evaluate the gas pressure which is sensed by the sensor. The controller can consequently determine in situ a reduced pressure which is caused, for example, by a leak or the like in the gas pressure reservoir. It is also conceivable that the at least one sensor, in addition to the gas pressure, also acquires a gas temperature and/or a gas intensity. The acquired sensor values (gas pressure, gas temperature, gas intensity) can be passed on to the controller, wherein an evaluation log is stored in the controller and on the basis thereof it can be determined whether gas has escaped or whether external influences, such as for example the external temperature or the gas volume in the axles of the chassis has decreased or increased. The external temperature is usually lower in the winter than in the summer.

In addition, the controller is also preferably designed to display, after a gas pressure which is lower than the specified gas pressure has been sensed, an indicator signal to a driver by means of an indicator device which alerts the driver to an excessively low gas pressure in the gas pressure reservoir. As a result, a driver of the utility vehicle can react immediately or soon and fill the gas pressure reservoir by means of an external compressed-gas supply unit, such as for example a compressor at a gas station or a workshop, or given the presence of a leak in the gas pressure reservoir can take corresponding measures to repair the gas pressure reservoir.

In addition, the indicator signal is preferably an optical signal and/or acoustic signal, in particular the indicator device is embodied as a lamp and/or as a sound generator, preferably on a dashboard of the vehicle. The indicator signal can be reproduced, for example, as an optical signal with different wavelengths. For example, such an optical signal could reproduce, in the form of a traffic light code, the reduction in pressure in the gas pressure reservoir in comparison with the specified gas pressure. For example, a green light could then display a small reduction in pressure, which then does not require refilling of the compressed gas. A yellow light could already indicate a relatively large reduction in pressure, which indicates that refilling of the gas pressure soon would be appropriate. A red light could indicate, for example, an insufficient pressure for the inflation of a tire and therefore indicate that the compressed gas has to be topped up as soon as possible. A similar indicator can additionally be provided, for example by means of an acoustic signal, wherein the acoustic pattern also indicates a corresponding loss of gas pressure here. In addition, it is conceivable to mix or superimpose such an optical signal and an acoustic signal.

The controller is preferably arranged in an electronic brake system (EBS). This has the advantage that a controller which is already present for evaluating the sensor signals can be used. There is consequently no need for any further component.

### BRIEF DESCRIPTION OF THE DRAWINGS

Further advantages and features of the present invention can be found in the following description of a preferred embodiment with reference to the appended FIGURE. In the drawing:

FIG. 1 shows a schematic plan view of a chassis which is connected to a tire inflation system.

### DETAILED DESCRIPTION OF THE PREFERRED EMBODIMENTS

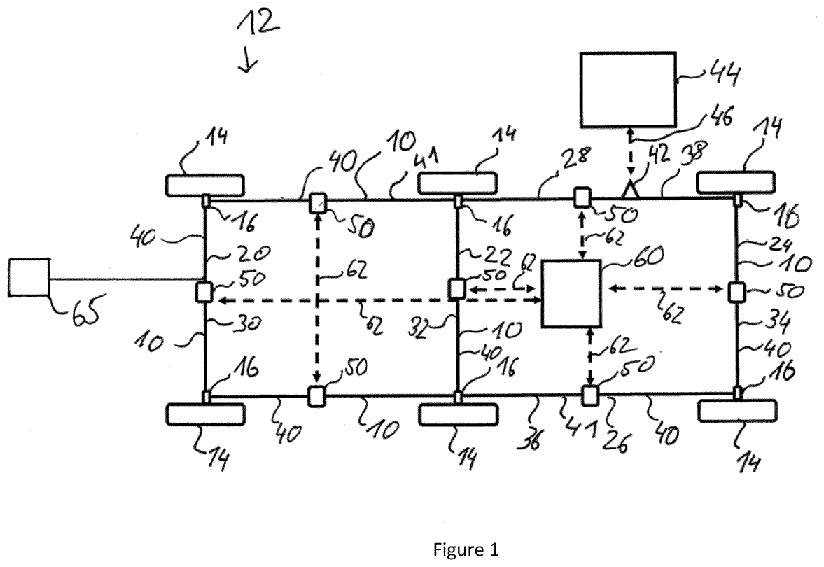

FIG. 1 shows a chassis 10 of a utility vehicle 12, in particular of a trailer. The utility vehicle 12 has tires 14 which are connected to the chassis 10 via an axle stub 16. The axles 20 to 28 of the chassis 10 each have a cavity 30 to 38 which serves as a gas pressure reservoir 40. The walls 41 of the gas pressure reservoir 40 have a compressive strength of at least 0.9 N/mm2 and preferably at least 1.4 N/mm2. The walls 41 of the gas pressure reservoir 40 can take or withstand a pressure of 9 bar, and preferably 14 bar or more, without the gas pressure reservoir 14 being damaged here.

In addition, an inflation unit 42, which when necessary can be connected to an external compressed-gas supply unit 44, is arranged on at least one axle 20 to 28 of the chassis 10. The pressure supply unit 44 is embodied, for example, as a compressor at a gas station or at a workshop. The temporary connectability of the compressed-gas supply unit 44 to the inflation unit 42 is indicated by the dashed double arrow 46.

If, for example, the at least one sensor 50 acquires a sensor signal which is correlated with the gas pressure, or a gas pressure in the gas pressure reservoir 40 which is lower than a specified gas pressure, in particular lower than 14 bar, the pressure signal which is acquired by the at least one sensor 50 is transmitted to a controller 60. As illustrated in FIG. 1, for example a plurality of sensors 50 can be arranged on the chassis 10, in particular one sensor 50 can be arranged on each of the axles 20 to 28. Each of these sensors 50 is designed to communicate with the controller 60. The communication of the sensors 50 with the controller 60 is indicated in each case by the double arrows 62. In addition, the sensors 50 can acquire different sensor signals which can each be correlated with the gas pressure. For example, the sensors 50 can sense a pressure or a temperature, or can carry out electronic or mechanical pressure measurement.

The controller 60 is designed to receive at least one sensor signal of the sensor 50, and to evaluate the same. If a result of a pressure evaluation of the controller 60 is, for example, that the specified gas pressure in the gas reservoir 40 is lower than the specified gas pressure, the reduced pressure in the gas pressure reservoir 40 is indicated, for example, by means of an indicator device 65, to a driver of the utility vehicle 12. The indicator device 65 can be embodied, for example, as a lamp and/or as a sound generator which is arranged on a dashboard of the utility vehicle.

By virtue of the fact that the gas pressure reservoir 40 has an increased gas pressure level and the axle stubs 16 are each embodied at least partially as gas reservoirs, a gas pressure in a tire 14 can be directly topped up if necessary, in particular without the use of a booster pump.

The user of the vehicle 12 therefore does not need to monitor the tire pressure in the tires 14 himself anymore. A user of the vehicle 12 must merely react when the controller 60 indicates via the indicator device 65 that the gas pressure accumulator 40 has a lower gas pressure than the specified gas pressure. In such a case, the gas pressure reservoir 40 can be topped up again with pressurized gas by means of the inflation device 42 and by means of the external compressed-gas supply unit 44.

Consequently, the proposed utility vehicle which has a chassis and a tire inflation system does not require either connection to a gas pressure vessel of a secondary consumer or a booster pump for boosting the gas pressure.

### LIST OF REFERENCE NUMBERS

10 Chassis
12 Utility vehicle
14 Tire
16 Axle stub
20-28 Axle
30-38 Cavity
40 Gas pressure reservoir
41 Wall
42 Inflation unit
44 External compressed-gas supply unit
46 Temporary connection
50 Sensor
60 Controller
62 Connection between controller 60 and sensor 50
65 Indicator device

1.-14. (canceled)

15. A utility vehicle, comprising:
a chassis on which a tire inflation system can be arranged;
wherein the chassis has at least one axle with a cavity;
wherein the axle includes a compressed-gas reservoir in which a gas is stored at a specified gas pressure for inflating a tire of the utility vehicle with the gas;
wherein the compressed-gas reservoir has a wall with a compressive strength of at least 1.4 N/mm2; and
wherein the compressed-gas reservoir is configured to be filled up to a gas pressure which is higher than the specified tire gas pressure, to at least 14 bar, by an external compressed-gas supply unit, wherein the external compressed-gas supply unit comprises a compressor at a gas station or a workshop.

16. The utility vehicle as claimed in claim 15, wherein the wall of the compressed-gas reservoir has biaxial compressive strength.

17. The utility vehicle of claim 15, wherein the wall of the compressed-gas reservoir has triaxial compressive strength.

18. The utility vehicle as claimed in claim 15, wherein the at least one axle of the chassis comprises a material which has a higher compressive strength than a compressive stress which is applied to the at least one axle by the specified tire gas pressure.

19. The utility vehicle as claimed in claim 15, wherein the utility vehicle does not include a booster pump in the system or line system for filling the compressed-gas reservoir.

20. The utility vehicle as claimed in claim 15, wherein the gas pressure reservoir is fluidically connected to at least one axle stub via which the gas can be conducted into a tire, wherein the axle stub is includes a gas reservoir.

21. The utility vehicle as claimed in claim 15, wherein the at least one axle of the chassis comprises an inflation unit that includes a valve device, for inflation with the gas by the external compressed-gas supply unit.

22. The utility vehicle as claimed in claim 21, wherein the valve device is bi-directional.

23. The utility vehicle as claimed in claim 15, further comprising:
at least one sensor for continuously acquiring a sensor signal correlated with the specified gas pressure, where the at least one sensor is arranged in the compressed-gas reservoir on the at least one axle.

24. The utility vehicle as claimed in claim 23, wherein the at least one sensor is connected to a controller which is designed to receive and evaluate the sensor signal which is acquired by the sensor.

25. The utility vehicle as claimed in claim 23, wherein the at least one sensor includes a multiplicity of sensors, wherein the multiplicity of sensors acquire different sensor signals, which signals can each be correlated with the gas pressure.

26. The utility vehicle as claimed in claim 25, where the multiplicity of sensors are configured to sense a pressure and/or temperature.

27. The utility vehicle as claimed in claim 25, wherein the controller is configured to display, after a gas pressure which is lower than the specified gas pressure has been sensed, an indicator signal to a driver by an indicator device which alerts the driver to an excessively low gas pressure in the compressed-gas reservoir.

28. The utility vehicle as claimed in claim 27, wherein the indicator signal is an optical signal and/or acoustic signal.

29. The utility vehicle as claimed in claim 28, wherein the indicator device comprises a lamp or sound generator located on a dashboard of the utility vehicle.

30. The utility vehicle as claimed in claim 24, wherein the controller is arranged in an electronic brake system.

31. The utility vehicle as claimed in claim 15, wherein the utility vehicle comprises a utility trailer.
